(19) United States
(12) Patent Application Publication
(10) Pub. No.: US 2003/0210704 A1
(43) Pub. Date: Nov. 13, 2003

(54) Very high data rate digital subscriber line modem

(76) Inventor: Yung-Chieg Tung, Hsinchu Hsien (TW)

Correspondence Address: BIRCH STEWART KOLASCH & BIRCH, PO BOX 747, FALLS CHURCH, VA, 22040-0747, US

(21) Appl. No.: 10/212,118

(22) Filed: Aug. 6, 2002

(30) Foreign Application Priority Data
May 10, 2002 (TW) 91109808

(51) Int. Cl. H04L 5/16

(52) U.S. Cl. 370/419; 375/222

(57) ABSTRACT

A very high data rate digital subscriber line (VDSL) modem. The VDSL modem comprises a plurality of first ports coupled to a plurality of local area networks, a second port coupled to a very high data rate digital subscriber line network, a flow control device coupled to the first ports, a transceiver coupled to the second port, a transmission device coupled between the transceiver and the flow control device, and a control device coupled between the flow control device and the transmission device to manage the flow control device and the transmission device.

### BACKGROUND OF THE INVENTION

1. Field of the Invention

The present invention relates in general to a very high data rate digital subscriber line (VDSL) modem. In particular, the present invention relates to a VDSL modem with one VDSL port and several local area network (LAN) ports.

2. Description of the Related Art

Digital Subscriber Line technology architectures, generally denoted as xDSL, allow digital distribution of data services with traditional narrowband voice transmissions.

One form of xDSL of particular interest to the present invention is very high data rate digital subscriber line (VDSL), a packet-based transmission architecture used to provide high bandwidth distribution of digital video and data signals to customers. The transmission capability of VDSL is higher than that of asymmetric digital subscriber line (ADSL) and cable modem.

VDSL services are typically implemented in an asymmetric form having a maximum downstream transmission capability of about 52 Mbps over twisted pair. Upstream data rates in asymmetric implementations range to about 2.3 Mbps. Utilizing 10BaseS technology, the maximum downstream and upstream transmission capability of VDSL both range to 26 Mbps. The transmission capability of VDSL is ten times than transmission capability of ASDL, but the effective transmission distance of the local packets is less than 2000 meters. VDSL technology utilizes Frequency Division Duplexing (FDD) to separate downstram and upstream channel, and further, standard or so-called Plain Old Telephone Service (POTS)/ISDN in the frequency domain. VDSL technology utilizes high frequency bandwidth to transmit video signals and other data information requiring high-speed transmission, middle frequency bandwidth to transmit control signals, and low frequency bandwidth to transmit POTS packets. The transmission end modulates signals to different bandwidths through twisted pair and optic fiber nodes to the user end.

A typical VDSL distribution system is similar to the typical ADSL distribution system. At the user end, it requires a modem to connect to the VDSL network. Typical telephone signals are transferred over a twisted-pair telephone line through a POTS coupler and splitter. High-definition television (HDTV), video on demand, and other video signals are transferred to the user end utilizing a VDSL upstream channel.

FIG. 1 is a diagram illustrating the configuration of the VDSL modem in the prior art. As shown in FIG. 1, a typical VDSL modem 100 comprises a local area network (LAN) port 102, a VDSL port 104, a public switched telephone network (PSTN) port 106, a transceiver 108, a splitter 110, a transmission device 112 and a packet processor 114.

The LAN port 102 is an Ethernet port coupled to the Ethernet 122. The LAN port 102 receives local packets from Ethernet 122 and inputs them to the packet processor 114. After processing the local packets, the packet processor 114 input them to transmission device 112. The transmission device 112 controls the flow of the local packets to the splitter 110. The splitter 110 is coupled to the VDSL port 104 and is also coupled to the PSTN port 106 through the splitter 110. According the frequency of the local packets, the splitter 110 transmits the local packets to the VDSL network 124 through the VDSL port 104 or to the PSTN 126 through the PSTN port 106.

The PSTN port 106 is coupled to the transmission device 112 through the splitter 110. The PSTN port 106 receives remote packets from the PSTN 126 and transmits them to the transceiver 108. The VDSL port 104 receives remote packets from the VDSL network 124 and transmits them to the transceiver 108. The transceiver 108 receives the remote packets from the PSTN port 106 and the VDSL port 104 and transmits them to the transmission device 112. The transmission device 112 controls the flow of the remote packets from the transceiver 108. The remote packets are through an error correction procedure in the transmission device 112. Then, the remote packets are input to the packet processor 114. The packet processor 114 transfers the remote packets to local packets that can be recognized by the Ethernet 122. Then, the local packets are transmitted to Ethernet 122 through the LAN port 102.

The typical ADSL modem 100 usually has only one LAN port. Only one Internet connection device can be connected to the VDSL network through the ADSL modem 100, an inconvenience for users. The user may use a notebook to connect to the VDSL network, and, at the same time, want to connect via video telephone through the VDSL network or to watch HDTV using a video on demand device to connect to the VDSL network. A need thus exists for a VDSL modem with several LAN ports to better serve the user.

### SUMMARY OF THE INVENTION

An object of the present invention is to provide a VDSL modem with one VDSL port and several local area network (LAN) ports for connection to a VDSL network through multiple devices at the same time.

The very high data rate digital subscriber line (VDSL) modem of the present invention comprises a plurality of first ports, a second port, a flow control device, a transceiver, a transmission device, and a control device. The first ports are coupled to a plurality of local area networks. The first ports receive a plurality of local packets from the local area networks and output a plurality of remote packets to the local area network. The second port is coupled to a very high data rate digital subscriber line (ADSL) network. The second port receives the remote packets and outputs the local packets to the very high data rate digital subscriber line network. The flow control device is coupled to the first ports. The flow control device controls the flow of the local packets output from the first ports and distributes the flow of the remote packets to the first ports. The transceiver is coupled to the second port. The transceiver receives the remote packets from the second port and transmits the local packets to the second port. The transmission device is coupled between the transceiver and the flow control device. The transmission device receives the local packets from the flow control device, makes the effective transmission distance of the local packets become further through a process procedure, controls the flow of the remote packets transmitted from the transceiver, and transmits the remote packets to the flow control device through an error correction procedure. The control device is coupled between the flow control device and the transmission device to manage the flow control device and the transmission device.

The local area networks of the present invention are Ethernet or Fast Ethernet. The first ports are Ethernet ports or Fast Ethernet ports. Each of the first ports is coupled to a video on demand device, a voice over Internet protocol device, a personal computer, a portable electronic device, or any other Internet connection device through an Ethernet line or a Fast Ethernet line.

Furthermore, the very high data rate digital subscriber line (VDSL) modem further comprises a third port coupled between a public switched telephone network and the transceiver, and a splitter coupled between the transceiver and the first and second ports.

### BRIEF DESCRIPTION OF THE DRAWINGS

The present invention can be more fully understood by reading the subsequent detailed description in conjunction with the examples and references made to the accompanying drawings, wherein:

FIG. 1 is a diagram illustrating the configuration of the VDSL modem in the prior art;

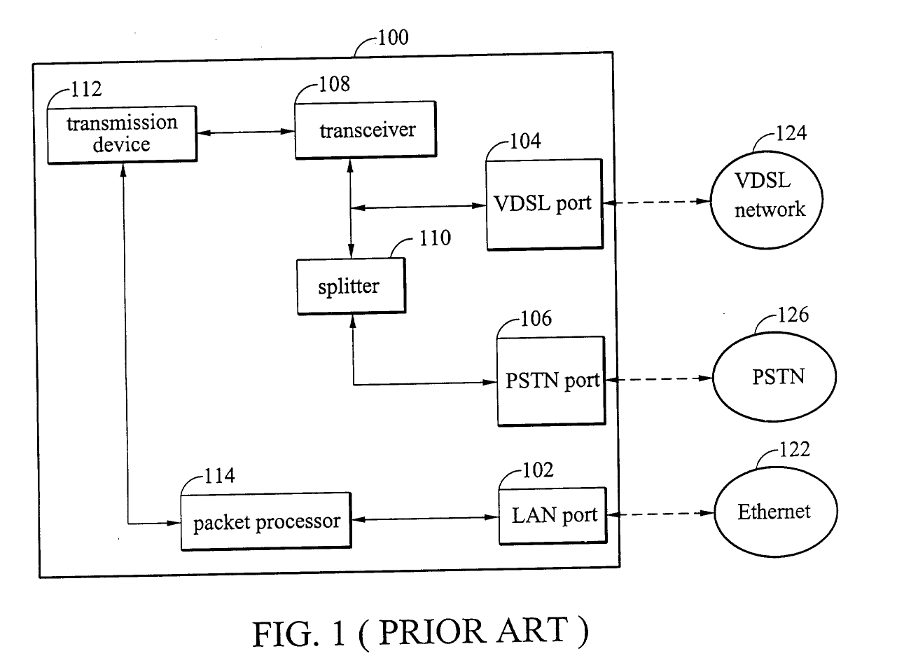

FIG. 2 is a diagram illustrating the configuration of the VDSL modem in the embodiment of the present invention; and

FIG. 3 is a diagram illustrating the appearance of the VDSL modem in the embodiment of the present invention.

### DETAILED DESCRIPTION OF THE INVENTION

The invention provides a VDSL modem with one VDSL port and several local area network (LAN) ports. At the same time, a user can use several Internet connection devices to connect a VDSL network through the VDSL modem. A video on demand device, a voice over Internet protocol device, a personal computer, a portable electronic device or any other Internet connection device may connect to local area network (LAN) ports through an Ethernet line or a Fast Ethernet line. Through the following description, the embodiments of the present invention can be understood in conjunction with the accompanying drawings.

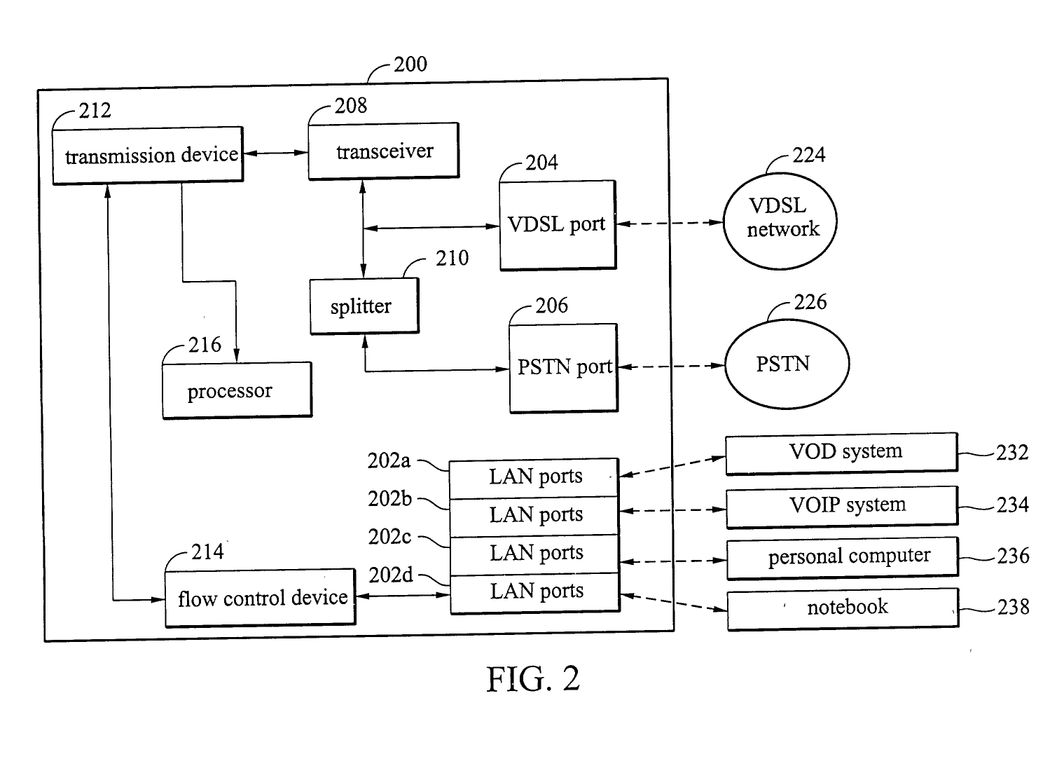

FIG. 2 is a diagram illustrating the configuration of the VDSL modem in the embodiment of the present invention. The VDSL modem 200 in the embodiment of the present invention is used in a system with 10BaseS technology. Utilizing 10BaseS technology, the maximum downstream and upstream transmission capability of VDSL will both reach 26 Mbps, and the effective transmission distance utilizing 10BaseS technology is between 1.35 and 2 kilometers. The VDSL modem 200 comprises four LAN ports 202a˜202d, a VDSL port 204, a PSTN port 206, a transceiver 208, a splitter 210, a transmission device 212, a flow control device 214 and a processor 216.

In the embodiment, the four LAN ports 202a˜202d are connected to different LAN systems. The LAN ports 202a and 202b are Fast Ethernet ports. The LAN ports 202c and 202d are Ethernet ports. Through one Fast Ethernet line (not shownn in FIG. 2), the LAN port 202a is coupled to a video on demand (VOD) system. Users of the VOD system can choose video information through the VDSL network. Through another Fast Ethernet line (not shown in FIG. 2), the LAN port 202b is coupled to a voice over Internet protocol (VOIP) system. VOIP utilizes an open network i.e. the VDSL network in the embodiment, to transmit voices and images, using packets. Through a telephone set, VOIP users can call each other anywhere, paying only network and local telephone bills. Through one Ethernet line (not shown in FIG. 2), the LAN port 202c is coupled to a personal computer 236. Through another Ethernet line (not shown in FIG. 2), the LAN port 202d is coupled to a notebook 238.

As described above, the four LAN ports 202a˜202d are connected to different LAN systems. Each of the four LAN ports 202a˜202d receives a plurality of local packets from its LAN system and outputs the local packets to the flow control device 214. The transmission capability to the flow control device 214 may be 10 Mbps or 100 Mbps. Thus, the flow control device 214 controls the flow of the local packets from the four LAN ports 202a˜202d. Then, the flow control device 214 transmits the local packets to the transmission device 212.

The transmission device 212 receives the local packets from the flow control device and increases the effective transmission distance of the local packets. The procedure increases the effective transmission distance of the local packets to between 1.35 and 2 kilometers. Then, the transmission device 212 transmits the local packets to the transceiver 208. The transmission device 212 also controls the flow of the local packets to the transceiver 208 and maintains the transmission capability to the transceiver 208 to be 12.5 Mbps.

The transceiver 208 is coupled to the VDSL port 204 and also to the PSTN port 206 through the splitter 210. According the frequency of the local packets, the transceiver 208 transmits the local packets to the VDSL network 224 through the VDSL port 204 or to the PSTN 226 through the PSTN port 206. For example, POTS packets with voice signals are transmitted from the LAN port 202b to the PSTN 226 utilizing low frequency bandwidth. Control signal packets for controlling VOD system are transmitted from the LAN port 202a to the VDSL network 224 utilizing middle frequency bandwidth. Packets with data information requiring high-speed transmission are transmitted from the LAN ports 202c and 202d to the VDSL network 224 utilizing high frequency bandwidth.

The PSTN port 206 is coupled to the transceiver 208 though the slipper 210 and receives remote packets from PSTN 226. The remote packets may be packets with voice signals. The PSTN port 206 transmits the remote packets to transceiver 208. The VDSL port 204 receives remote packets from the VDSL network 224 and transmits the remote packets to transceiver 208. The remote packets may be packets with VOD signals or packets with data information requiring high-speed transmission. The transceiver 208 receives the remote packets from the VDSL port 204 and the PSTN port 206 and transmits them to the transmission device 212. The transmission device 212 controls the flow of the remote packets from the transceiver 208, and transmits the remote packets to the flow control device 214 through an error correction procedure. The error correction procedure comprises detecting a plurality of errors of the remote packets and recovering the errors. The flow control device 214 distributes the flow of the remote packets to the LAN ports. The flow control device 214 transfers the remote packets to local packets that can be recognized by the different LAN systems. Then, the local packets are transmitted to different LAN systems through different LAN ports according to their types. For example, packets with voice signals are transmitted to the LAN port 202b. Then, through the Fast Ethernet line, the packets with voice signals are transmitted to the VOIP system 234. Packets with VOD signals are transmitted to the LAN port 202a. Then, through the Fast Ethernet line, the packets with VOD signals are transmitted to the VOD system 232. Packets with data information requiring high-speed transmission are transmitted to the LAN ports 202c or 202d. Then, through the Ethernet line, the packets are transmitted to the personal computer 236 or the notebook 238.

The processor 216 is coupled between the flow control device 214 and the transmission device 212 to manage the flow control device 214 and the transmission device 212. The processor 216 detects whether the LAN ports 202a˜202d have errors or not. If the processor 216 detects an error, the processor 216 must take some action, such as stopping the operation of the LAN port that produces the error or recovering the error. The processor 216 also controls the flow control device 214 to set priority of the LAN ports 202a˜202d to provide instantaneous voice or video transmission. Thus, the VOD or VOIP service will have higher quality. In order to do so, typically, packets with voice or video signal have higher priority than packets with data information. Thus, the packets from the LAN ports 202a and 202b have higher priority than packets from the LAN ports 202c and 202d. Furthermore, the processor 216 also controls the error correction procedure and the process procedure of the transmission device 212.

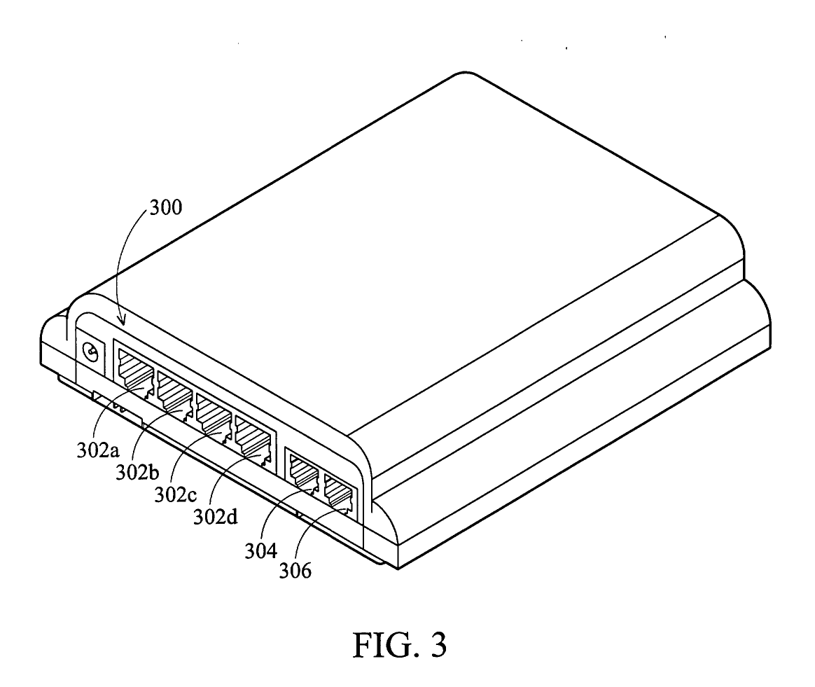

FIG. 3 is a diagram illustrating the appearance of the VDSL modem in the embodiment of the present invention. As shown in FIG. 3, the VDSL modem 300 of the present invention has four LAN ports 302a˜302d, one VDSL port 304 and one PSTN port 306.

The four LAN ports 302a˜302d are connected to different LAN systems. Each of the four LAN ports 202a˜202d receives a plurality of local packets from its LAN system and transmits them to the VDSL modem 300. The VDSL modem 300 transmits local packets to the VDSL network through the VDSL port 304 or to the PSTN through the PSTN port 306 according the frequency of the local packets.

Furthermore, remote packets from the PSTN are received by the PSTN port 306 and are transmitted into the VDSL modem 300. Remote packets from the VDSL network are also received by the VDSL port 304 and are transmitted into the VDSL modem 300. The VDSL modem 300 transmits the remote packets to different LAN systems through different LAN ports according to the types of the remote packets.

As described above, the VDSL modem provided by the present invention supports several LAN ports. Because a user can use several Internet connection devices to f through the VDSL modem, the VDSL modem can varied VDSL service at the same time.

Finally, while the invention has been described by way of example and in terms of the preferred embodiment, it is to be understood that the invention is not limited to the disclosed embodiments. On the contrary, it is intended to cover various modifications and similar arrangements as would be apparent to those skilled in the art. Thus, the scope of the appended claims should be accorded the broadest interpretation so as to encompass all such modifications and similar arrangements.

What is claimed is:

1. A very high data rate digital subscriber line modem, comprising:
a plurality of first ports coupled to a plurality of local area networks, the first ports receiving a plurality of local packets from the local area networks and outputting a plurality of remote packets to the local area networks;
a second port coupled to a very high data rate digital subscriber line network, the second port receiving the remote packets from the very high data rate digital subscriber line network and outputting the local packets to the very high data rate digital subscriber line network;
a flow control device coupled to the first ports, the flow control device controlling the flow of the local packets output from the first ports and distributing the flow of the remote packets to the first ports;
a transceiver coupled to the second port, the transceiver receiving the remote packets from the second port and transmitting the local packets to the second port;
a transmission device coupled between the transceiver and the flow control device, the transmission device receiving the local packets from the flow control device, extending the effective transmission distance of the local packets through a process procedure, controlling the flow of the remote packets transmitted from the transceiver and transmitting the remote packets to the flow control device through an error correction procedure; and
a control device coupled between the flow control device and the transmission device to manage the flow control device and the transmission device.

2. The very high data rate digital subscriber line modem as claimed in claim 1, further comprising a third port coupled between a public switched telephone network and the transceiver, wherein the third port receives the remote packets from the public switched telephone network, transmits the remote packets to transceiver, receives the local packets from the transceiver, and transmits the local packets to the public switched telephone network.

3. The very high data rate digital subscriber line modem as claimed in claim 1, further comprising a splitter coupled between the transceiver and the first and second ports, wherein the splitter receives the local packets from the transceiver, splits the local packets according to their frequency, transmits the local packets to the first or second ports according to the frequency of the local packets, and receives the remote packets form the first and second port.

4. The very high data rate digital subscriber line modem as claimed in claim 1, wherein the process procedure makes the effective transmission distance of the local packets between 1.35 and 2 kilometers.

5. The very high data rate digital subscriber line modem as claimed in claim 1, wherein the error correction procedure comprises detecting a plurality of errors of the remote packets and recovering the errors.

6. The very high data rate digital subscriber line modem as claimed in claim 1, wherein the control device controls the flow control device to detect a plurality of errors of the first ports and set priority of the first ports.

7. The very high data rate digital subscriber line modem as claimed in claim 1, wherein the control device controls the error correction procedure and the process procedure.

8. The very high data rate digital subscriber line modem as claimed in claim 1, wherein the control device is a central processing unit.

9. The very high data rate digital subscriber line modem as claimed in claim 1, wherein the local area networks are a plurality of Fast Ethernet networks.

10. The very high data rate digital subscriber line modem as claimed in claim 9, wherein each of the first ports is coupled to a video on demand device, a voice over Internet protocol device, a personal computer, a portable electronic device or any other Internet connection device through a Fast Ethernet line.

11. The very high data rate digital subscriber line modem as claimed in claim 9, wherein the portable electronic device is a notebook.

12. The very high data rate digital subscriber line modem as claimed in claim 9, wherein the portable electronic device is a personal digital assitant.

13. The very high data rate digital subscriber line modem as claimed in claim 1, wherein the local area networks are a plurality of Ethernet networks.

14. The very high data rate digital subscriber line modem as claimed in claim 14, wherein each of the first ports is coupled to a video on demand device, a voice over Internet protocol device, a personal computer, a portable electronic device or any other Internet connection device through an Ethernet line.

15. The very high data rate digital subscriber line modem as claimed in claim 14, wherein the portable electronic device is a notebook.

16. The very high data rate digital subscriber line modem as claimed in claim 14, wherein the portable electronic device is a personal digital assitant.
